(19) United States
(12) Patent Application Publication
(10) Pub. No.: US 2026/0346276 A1
(43) Pub. Date: Nov. 5, 2026

(54) Nozzle Assembly

(71) Applicants: Dirk Zimmermann, Wehr (DE); Jochen Thies, Lörrach (DE); Michael Trefzer, Lörrach (DE)

(72) Inventors: Dirk Zimmermann, Wehr (DE); Jochen Thies, Lörrach (DE); Michael Trefzer, Lörrach (DE)

(21) Appl. No.: 19/101,734

(22) PCT Filed: Aug. 7, 2023
(86) PCT No.: PCT/EP2023/071810

§ 371 Date: Feb. 6, 2025

(30) Foreign Application Priority Data
Aug. 10, 2022 (DE) 10 2022 120 146.5

(51) Int. Cl. B05B 1/14; B05B 7/06

(52) U.S. Cl. CPC B05B 1/1424; B05B 7/066

(57) ABSTRACT

A nozzle assembly having a line assembly and a nozzle main body connected on an outlet side to the line assembly having at least one nozzle, wherein on an outlet-side inner line end portion of an inner line and on the nozzle main body one coupling element is arranged in each case. One coupling element is designed as a first coupling element and one coupling element is designed as a second coupling element, wherein the coupling elements can be coupled to one another by a plug connection such that in the assembled state of the nozzle assembly, the inner line is connected to the nozzle main body and the medium to be sprayed can flow from the inner line in the direction of the at least one nozzle.

### CROSS-REFERENCE TO RELATED APPLICATIONS

This application is the United States national phase of International Patent Application No. PCT/EP2023/071810 filed Aug. 7, 2023, and claims priority to German Patent Application No. 10 2022 120 146.5 filed Aug. 10, 2022, the disclosures of which are hereby incorporated by reference in their entireties.

### BACKGROUND

### Field

The invention relates to a nozzle assembly having a line assembly which comprises an outer line conducting a gaseous medium and an inner line conducting a medium to be sprayed and arranged within the outer line, having a nozzle main body, wherein a coupling element is arranged on an outlet-side inner line end portion of the inner line and on the nozzle main body respectively, wherein a coupling element is formed as a first coupling element and a coupling element is formed as a second coupling element with respect to this, the coupling elements being adapted to be coupled to one another by means of a plug connection.

### Description of Related Art

Nozzle assemblies are already known from the prior art:

EP 1 871 534 B1 discloses a spray nozzle for a fluidized bed device with a central liquid outlet for a liquid coating agent and an annular air outlet for the coaxial supply of atomizing air, wherein the annular air outlet is defined by an enveloping body that can be held in a wall of the housing of the fluidized bed that the enveloping body comprises a central bore and is connected to a source of atomizing air via an air pipe, that an axially displaceable nozzle head is mounted centrally within the enveloping body, in which nozzle head the central liquid outlet is formed, the nozzle head bearing against an axial stop within the that the nozzle head is connected to a source for the liquid coating agent via a liquid pipe, wherein the liquid pipe comprises a flexible pipe section in the area of a curvature and is guided centrically within the air pipe and that the liquid pipe is mounted in a closure in the air pipe so as to be axially displaceable.

DE 10 2016 122 133 A1 discloses a line assembly of a spray nozzle assembly, wherein the spray nozzle assembly comprises both a flexible inner line and a flexible outer line. The spray nozzle assembly is also equipped with a nozzle head and a connector that are designed to be inserted into a nozzle head holder and into a coupling piece of a treatment module, between which a sheath tube of the treatment module, which receives the line assembly, extends. This allows the line assembly to be positioned very precisely as a whole and, in particular, without any adjustment work on the nozzle head in an application position.

### SUMMARY

The disadvantage of the nozzle assemblies shown in the prior art is that the coupling of the inner line to the nozzle main body is designed as a hose-connecting nozzle combination, which only allows coupling or uncoupling after the nozzle assembly has been disassembled.

The objective of the invention is therefore to provide a nozzle assembly that overcomes the disadvantages of the prior art.

This objective is achieved in a nozzle assembly of the type mentioned at the beginning by the fact that the first coupling element is designed as a coupling head through which a coupling head channel system passes and the second coupling element is designed as a receiving bushing comprising a receiving space so that in the assembled state of the nozzle assembly the inner line is connected to the nozzle main body and the medium to be sprayed can flow from the inner line in the direction of the at least one nozzle. Such an embodiment of the first and second coupling elements makes it possible to couple or decouple the nozzle assembly even when it is assembled.

In a nozzle assembly advantageous in this respect, the first coupling element (39a) is arranged on the inner line end portion of the inner line and the second coupling element is arranged on the nozzle main body. The assignment of the first coupling element to the inner line end portion and of the second coupling element to the nozzle main body allows a less complex design of the nozzle assembly and is thus more cost-effective.

Furthermore, the receiving space is defined by a receiving bushing wall and a receiving bushing floor.

In a favorable embodiment of the nozzle assembly, the coupling head channel system comprises an inlet channel having a longitudinal axis, transitioning in a transition region into a plurality of outlet channels opening out on a surface area of the coupling head. In particular, the plurality of outlet channels is arranged at an angle to the longitudinal axis of the inlet channel and/or the outlet channels are arranged so as to be uniformly distributed in the circumferential direction of the coupling head. The nozzles arranged in the nozzle main body can be advantageously supplied with the medium to be sprayed by means of such an assembly of the outlet channels.

Preferably, each outlet channel comprises an outlet channel cross-sectional area that is a multiple smaller than an inlet channel cross-sectional area. Accordingly, the outlet channels comprise a screening function in that, due to their outlet channel cross-sectional area being several times smaller than the inlet channel cross-sectional area, they retain coarse impurities carried in the medium to be sprayed that could clog the nozzles arranged in the nozzle main body. In the event that the outlet channels of the coupling head channel system are clogged by large impurities, it is possible to easily remove and replace the inner line, including the coupling head, even during the process, without dissembling the nozzle assembly. Preferably, each outlet channel comprises an outlet channel cross-sectional area that is smaller than a nozzle outlet cross-sectional area. This additionally ensures that any unretained impurities from the outlet channels can also pass through a nozzle outlet unhindered and do not block or, in the worst case, clog the nozzle.

According to a further advantageous embodiment of the nozzle assembly, the coupling head comprises a coupling head fastening device for the inner line, the coupling head fastening device being expediently being designed as a coupling head fastening sleeve having an internal thread or a first latching element. Preferably, the coupling head fastening device has the coupling head channel system passing through it. The inner line can be connected easily and permanently to the coupling head via such a coupling head fastening device, and the medium to be sprayed can flow through it.

In the case of an advantageously further developed nozzle assembly, the coupling head comprises a cap element positioned on the coupling head fastening sleeve, the cap element passes through the coupling head fastening device on the rear side with a coupling head connection spout. The cap element positioned on the coupling head fastening sleeve enables an optimized adaptation of the first coupling element, designed as a coupling head, to the second coupling element, designed as a receiving bushing. In addition, the connection of the inner line to the coupling head is further improved and permanently secured by the coupling head connection spout. Preferably, the coupling head connection spout is coaxially enclosed by the coupling head fastening device, expediently by the coupling head fastening spout, and more preferably the inlet channel is coaxially enclosed by the coupling head connection spout. Furthermore, a space is formed between the coupling head connection spout and the coupling head fastening sleeve, into which space the inner line, which comprises an external thread or a second latch element at its end section, can be introduced, so that the internal thread or the first latch element of the coupling head fastening sleeve and the external thread or the second latch element of the inner line are operatively connected to one another. This ensures that the inner line is easily and permanently attached to the first coupling element designed as a coupling head.

After an additional advantageous further development of the nozzle assembly, the first coupling element, designed as a coupling head, comprises a coupling head sealing element which provides a seal between the first and second coupling elements in the assembled state, so that the coupling head and the receiving bushing define a distribution space, the coupling head expediently comprising a coupling head groove over its entire circumference for receiving the coupling head sealing element. The coupling head sealing element advantageously allows the medium to be sprayed to escape from the distribution space only in the direction of the nozzle.

According to a particularly advantageous embodiment of the nozzle assembly, the nozzle main body has passing through it a first nozzle main body channel system for the gaseous medium and a second nozzle main body channel system for the medium to be sprayed, in order to conduct the corresponding media separately from one another from the line assembly to the nozzle. For this purpose, the first nozzle main body channel system comprises at least a number of nozzle main body supply lines corresponding to the number of nozzles arranged in the nozzle main body, in order to conduct the gaseous medium to the respective nozzle. It is expedient to assign two nozzle main body supply lines to each nozzle. The advantage of this embodiment is that a better air distribution for atomizing the medium to be sprayed is ensured at the nozzle outlet. The second nozzle main body channel system comprises a number of nozzle main body supply lines corresponding to a number of nozzles arranged in the nozzle main body, in order to supply the medium to be sprayed to the respective nozzle.

The nozzle main body supply lines of the second nozzle main body channel system preferably connect the distribution space and the respective nozzle. The two nozzle main body channel systems ensure a very simple and maintenance-free supply of the gaseous and the medium to be sprayed to the nozzle main body.

The nozzle main body is preferably designed in two parts, a nozzle main body cover and a nozzle main body pot being expediently connected to each other by means of a bayonet coupling or a thread. The connection and fixing of the nozzle main body cover and the nozzle main body pot is thus achieved by a twist-and-push movement. The advantage of this connection is that even in the event of mechanical shocks, the nozzle main body cover and nozzle main body pot do not come loose from each other, so that the nozzles are not cut off from a media supply despite the quick and easy replaceability of the nozzle main body pot.

According to an additional advantageous further development of the nozzle assembly, the inner line arranged within the outer line comprises a flexible inner line portion which is expediently guided by at least one spacer within the outer line. In this respect, the flexible inner line portion is preferably arranged in a region of a curvature of the line assembly. The spacers always position the inner line in the desired position in the outer line. Preferably, the inner line arranged within the outer line is surrounded coaxially by the outer line. The flexible inner line portion is particularly preferably under pre-load, whereby the first coupling element is held in the second coupling element. In this regard, the pre-load is generated in particular by the internal spring force of the flexible inner line portion.

Additionally, the nozzle assembly has a connector on the supply side that can be connected to the line assembly. This allows for easy and uncomplicated connection of the line assembly to the existing line network.

### BRIEF DESCRIPTION OF THE DRAWINGS

The terms Fig., Figs., Figure, and Figures are used interchangeably in the specification to refer to the corresponding figures in the drawings.

The invention is described in more detail in the following, using the accompanying drawings, and illustrates in

FIG. 1 a plan view of an embodiment of the nozzle assembly,

FIG. 2 a sectional view of the nozzle assembly through a sectional plane A-A as shown in FIG. 1,

FIG. 3 a view of the detailed section B of the nozzle assembly shown in FIG. 2,

FIG. 4 a bottom view of one embodiment of the nozzle assembly,

FIG. 5 a front view of the flexible inner line portion comprising a coupling head,

FIG. 6 a sectional view of the flexible inner line portion through a sectional plane C-C as shown in FIG. 5,

FIG. 7 a side view of the coupling head and

FIG. 8 a sectional view of the coupling head through a sectional plane D-D as shown in FIG. 7.

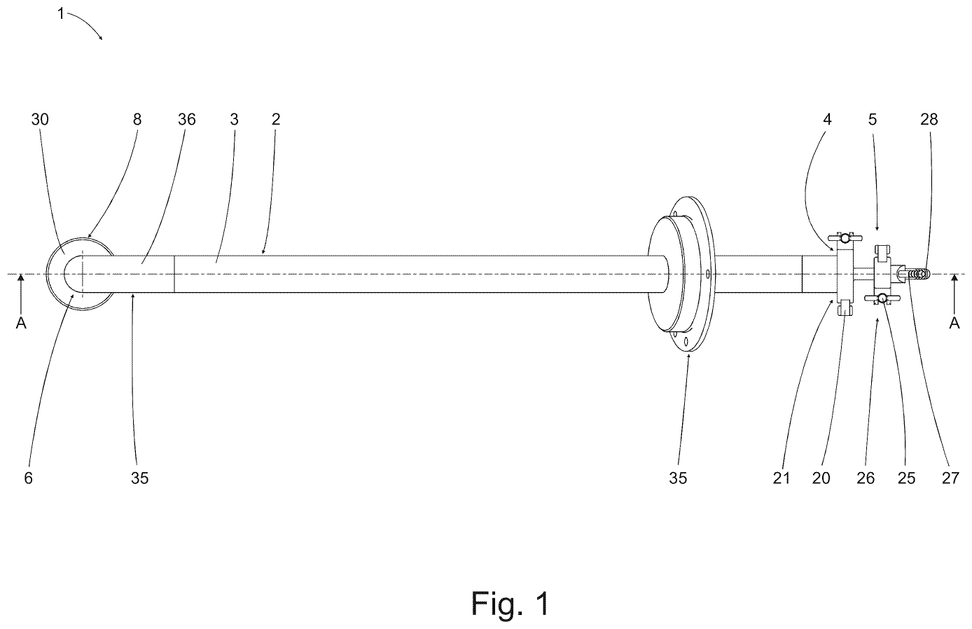

FIG. 1 shows a plan view of an embodiment of the nozzle assembly 1.

The nozzle assembly 1 shown in FIG. 1 comprises a line assembly 2 that has an outer line 3 that conducts a gaseous medium. A connector 5 is attached to a supply side 4 of the line assembly 2, while a nozzle main body 8 comprising at least one nozzle 7 is attached to an outlet side 6 of the line assembly 2 that is located opposite the supply side 4.

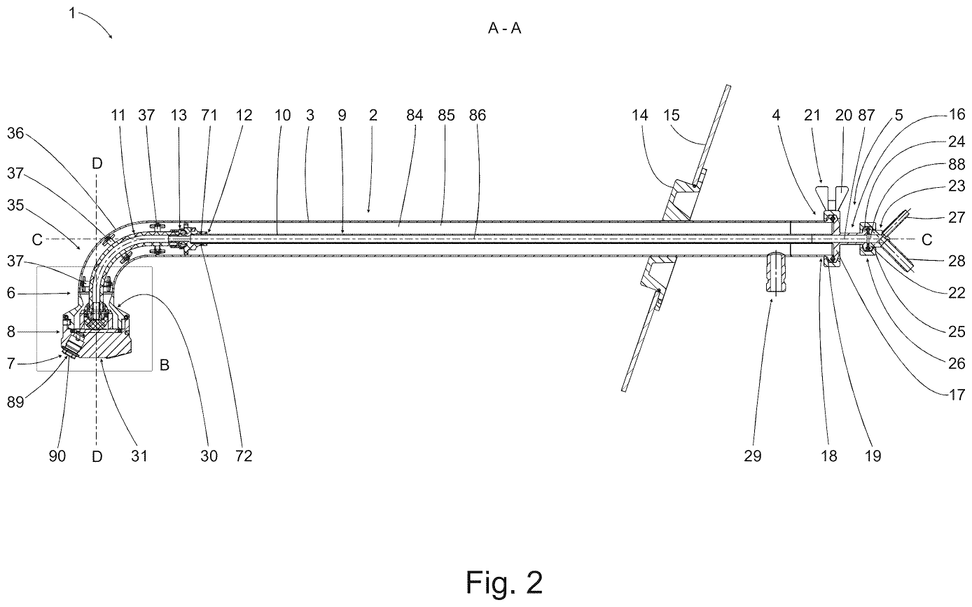

FIG. 2 shows a sectional view of nozzle assembly 1 through a sectional plane A-A as shown in FIG. 1.

### DETAILED DESCRIPTION

The line assembly 2 comprising the outer line 3 carrying the gaseous medium comprises an inner line 9 carrying a medium to be sprayed and arranged within the outer line 3. An annular gap 85 serving as an outer line flow channel 84 is formed between the outer line 3 and the inner line 9. In the embodiment shown, the inner line 9, which is arranged within the outer line 3 and forms an inner line flow channel 86, is surrounded coaxially by the outer line 3.

The inner line 9 is designed in several parts. Accordingly, the inner line 9 comprises a rigid inner line portion 10, preferably a straight pipe made of metallic material, and a flexible inner line portion 11, which adjoins the rigid inner line portion 10 and is preferably formed as a fabric-reinforced silicone hose or as a Guttasyn hose. The rigid inner line portion 10 is held in the outer line 3 on the supply side 4 of the line assembly 2 by the connector 5 and is connected to a connecting element 13 on a side 12 of the rigid inner line portion 10 facing away from the supply side 4. The flexible inner line portion 11 is connected to the connecting element 13 on the supply side and to the nozzle main body 8 on the outlet side 6 of the line assembly 2.

A mounting flange 14 is arranged on the outer line 3 of the line assembly 2, which is arranged in a conically designed outer surface section 15 of a treatment module not shown in more detail, in a mounting plane C-C aligned perpendicular to the sectional plane A-A. In the treatment module, the nozzle assembly 1 shown is used in particular to generate a top spray. The treatment module is preferably designed as a coating device, such as a drum coater, or as a fluidizing apparatus, such as a fluidized bed or spouted bed apparatus.

The connector 5 comprises a double flange 16 forming a double flange flow channel 87, the outlet side flange 17 of which is connected to an outer line end section flange 19 arranged on an outer line end section 18 in such a way that the inner line 9 and the outer line 3 of the line assembly 2 are sealed on the supply side 4. For this purpose, the flange 17 and the outer line end portion flange 19 are clamped in the axial direction by means of a clamping device 21 designed as a tri-clamp 20. In addition to the double flange 16, the connector 5 further comprises an inner line coupling element 23 having an outlet side inner line coupling element flange 22 and forming an inner line coupling element flow channel 88, the inner line coupling element flange 22 being connected to the supply side flange 24 of the double flange 16 and clamped in the axial direction by means of a clamping device 26 designed as a tri-clamp 25, so that the double flange 16, which extends the inner line 9 of the line assembly 2, is sealed on the supply side 4 of the line assembly 2. In this respect, the inner line flow channel 86 is connected to the double flange flow channel 87 and the inner line coupling element flow channel 88 in terms of flow.

The inner line coupling element 23 comprises a coupling element connection 27 for supplying the medium to be sprayed, expediently a liquid, a dispersion, an emulsion or a suspension, and a coupling element connection 28 for supplying a rinsing medium expediently configured as rinsing air. The embodiment of the connector 5 described makes it possible to replace the inner line coupling element 23 very easily, which means that the coupling element connections 27, 28 can be changed efficiently.

Outer line 3 is connected to a connecting stub 29, onto which an outer line coupling element (not shown) can be attached, via which the pressurized gaseous medium, expediently spray air, can be supplied.

On the outlet side, the outer line 3 and the inner line 9 are connected to the two-part nozzle main body 8, the outer line 3 being connected to a nozzle main body cover 30 and the inner line 9, preferably the flexible inner line element 11, being connected to a nozzle main body pot 31. The nozzle main body cover 30 and the nozzle main body pot 31 are connected to one another by means of a bayonet coupling, the bayonet coupling being sealed by sealing elements 33a,b in the form of ring seals 32a,b. The sealing elements 33a,b are each arranged in a groove 34a,b associated with the nozzle main body cover 30 or the nozzle main body pot 31. In a embodiment not shown, the nozzle main body pot 31 and the nozzle main body cover 30 are connected by means of a thread, the nozzle main body cover 30 expediently comprising an external thread and the nozzle main body pot 31 comprising an internal thread.

The redirection of the media from a horizontal mounting level C-C to a vertical spray level D-D, which is necessary for a top spray, takes place in the area of a curvature 35 of the line assembly 2, which is particularly formed by a 90° elbow 36, as shown in the embodiment.

In the area of curvature 35, the inner line 9 arranged within the outer line 3 comprises the flexible inner line portion 11, the flexible inner line portion 11 being expediently guided, as shown in the embodiment, by spacers 37 within the outer line 3. In the embodiment, three spacers 37 are used.

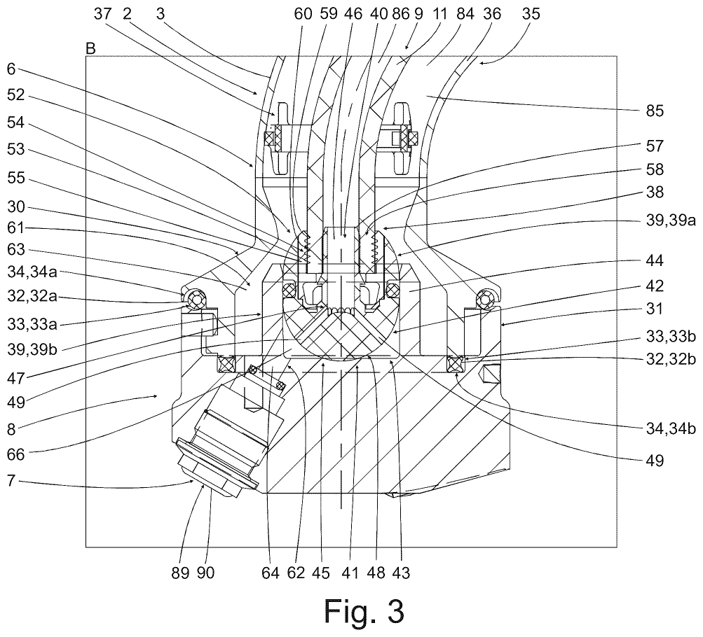

An enlarged view of the detailed section B of nozzle assembly 1 shown in FIG. 2 is presented in FIG. 3. The nozzle main body 8 is connected to the outer line 3 by means of the nozzle main body cover 30, in particular welded. Furthermore, the nozzle main body 8 is detachably connected to the inner line 9 by means of the nozzle main body pot 31. For the detachable connection between the inner line 9 and the nozzle main body 8, a coupling element 39 is arranged on an outlet side inner line end portion 38 of the inner line 9 and on the nozzle main body pot 31. In this regard, one coupling element 39 is designed as a first coupling element 39a and one coupling element 39 is designed as a second coupling element 39b, it being possible for the coupling elements 39 to be coupled to one another by means of a plug connection. In the embodiment shown, the first coupling element 39a is arranged on the inner line end portion 38 of the inner line 9 and the second coupling element 39b is arranged on the nozzle main body 8. The first coupling element 39a is fixed in the second coupling element 39b by virtue of the fact that the flexible inner line portion 11 of the inner line 9, on which the first coupling element 39a is arranged, is under pre-load.

The first coupling element 39a is designed as a coupling head 41 penetrated by a coupling head channel system 40, and the second coupling element 39b is designed as a receiving bushing 43 having a receiving space 42, so that in the assembled state of the nozzle assembly 1, the inner line 9 is connected to the nozzle main body 8, preferably the nozzle main body pot 31. The medium to be sprayed can thereby flow through the inner line flow channel 86 and the coupling head channel system 40 in the direction of the three nozzles 7. In the embodiment, the receiving space 42 of the receiving bushing 43 is confined by a receiving bushing wall 44 and a receiving bushing floor 45.

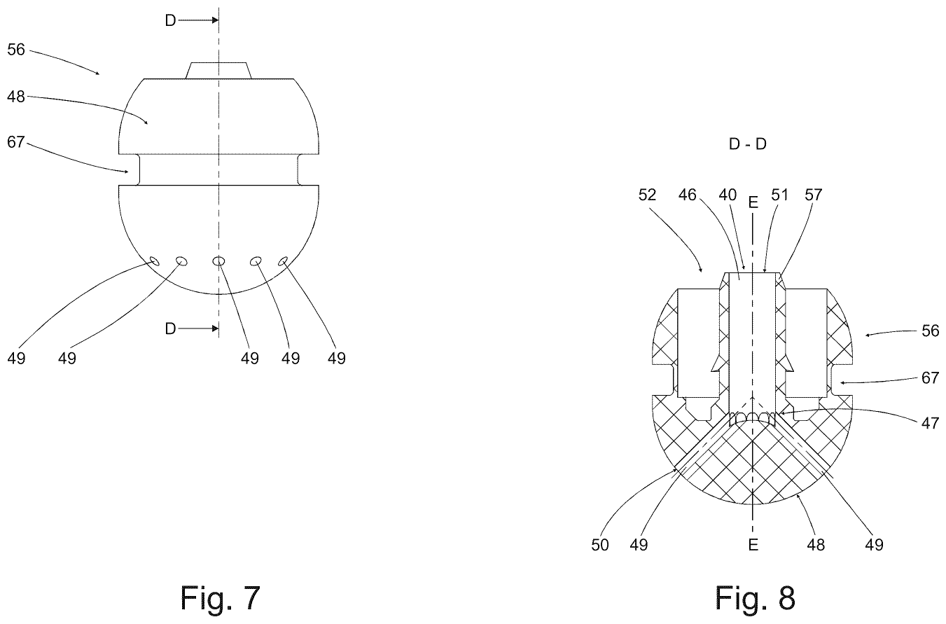

The coupling head channel system 40 comprises an inlet channel 46 that has a longitudinal axis E-E and transitions in a transition region 47 into a plurality of outlet channels 49 that open onto a surface area 48 of the coupling head 41. In the embodiment shown, the plurality of outlet channels 49 is arranged at an angle to the longitudinal axis E-E of the inlet channel 46. Furthermore, as can be seen more easily in FIG. 7, the outlet channels are arranged so as to be uniformly distributed in the circumferential direction of the coupling head 41. In addition, each outlet channel 49 comprises an outlet channel cross-sectional area 50 that is many times smaller than an inlet channel cross-sectional area 51. The smaller outlet channel cross-sectional area 50 compared to the inlet channel cross-sectional area 51 results in a screening effect that allows to filter out coarse impurities in the medium to be sprayed. Furthermore, each outlet channel 49 expediently comprises an outlet channel cross-sectional area 50 that is smaller than a nozzle outlet cross-sectional area 89 at the nozzle outlet 90 of the nozzle 7. This additionally ensures that any impurities not retained by the outlet channels 49 can also transfer the nozzle outlet 90 unhindered and can be sprayed without clogging or, in the worst case, blocking the nozzle 7, in particular at its nozzle outlet 90.

The coupling head 41 comprises a coupling head fastening device 52 for the inner line 9, wherein the coupling head fastening device 52 is advantageously designed as a coupling head fastening sleeve 55 comprising a first latch element 54 having latching catches 53. In this case, the coupling head fastening device 52 is penetrated by the coupling head channel system 40, in particular by the inlet channel 46.

In addition, the coupling head 41 comprises a cap element 56 that is positioned on the coupling head fastening sleeve 55 and passes through the coupling head fastening device 52 with a coupling head connection spout 57 at the rear. The cap element 56 is preferably a plastic with the material designation PA2200 and is produced in particular as a 3D component in a laser sintering process. The PA2200, which is based on PA12, offers a wide range of possible uses. In addition, it meets all requirements for biocompatibility. The coupling head connection spout 57 is coaxially enclosed in the shown embodiment by the coupling head fastening device 52, in particular by the coupling head fastening sleeve 55. At the same time, the inlet channel 46 is also coaxially surrounded by the coupling head connection spout 57.

The constructive design of the coupling head 41 results in a space 58 being formed between the coupling head connection spout 57 and the coupling head fastening sleeve 55, in which the inner line 9 can be introduced, which comprises, at its inner line end portion 38, a second latch element 60 configured as the first latch element 54 receiving latch recess 59, so that the first latch element 54 of the coupling head fastening sleeve 55 and the second latch element 60 of the inner line 9, in particular of the flexible inner line portion 11, are operatively connected to one another. Coupling head 41 can also be connected to the outlet-side inner line end portion 38 of the inner line 9 by means of a different connection technique, for example by means of a thread, with an internal thread being arranged on the coupling head fastening sleeve 55 and an external thread being arranged on the inner line end portion 38 of the inner line 9.

The first coupling element 39a, designed as a coupling head 41, comprises a coupling head sealing element 65 which, in the assembled state, has a sealing effect between the first and second coupling elements 39a,b, so that the coupling head 41 and the receiving bushing 43 define a distribution space 66, wherein the coupling head 41 expediently comprises a coupling head groove 67 over its entire circumference for receiving the coupling head sealing element 65. The coupling head sealing element 65 is preferably designed as an annular seal 68. By introducing the medium to be sprayed into the distribution space 66, it is distributed uniformly to the individual nozzles 7 arranged in the nozzle main body 8.

To supply the nozzles 7 arranged on the two-part nozzle main body 8 with the media provided by the line assembly 2, the nozzle main body 8 is penetrated by a first nozzle main body channel system 61 for the gaseous medium and a second nozzle main body channel system 62 for the medium to be sprayed. This ensures that the corresponding media can be directed separately from the line assembly 2 to the nozzle 7.

The first nozzle main body channel system 61 comprises at least a number of nozzle main body supply lines 63 corresponding to the number of nozzles 7 arranged in the nozzle main body 8, in order to conduct the gaseous medium to the respective nozzle 7. In the embodiment shown, two nozzle main body supply lines 63 are assigned to each nozzle. At the nozzle outlet 90 of nozzle 7, the two nozzle main body supply lines 63 ensure improved air distribution for atomizing the medium to be sprayed. This also further reduces any deposits of the medium to be sprayed that may occur at the nozzle outlet. The gaseous medium thus flows through the outer line flow channel 84 via the nozzle main body supply lines 63 to the nozzle 7. The aforementioned connection of all flow channels for the gaseous medium is also referred to as the outer flow channel. The second nozzle main body channel system 62 also comprises a number of nozzle main body supply lines 64 corresponding to the number of nozzles 7 arranged in the nozzle main body 8, in order to conduct the medium to be sprayed to the respective nozzle 7. In this case, the nozzle main body supply lines 64 of the second nozzle main body channel system 62 connect the distribution space 66 and the respective nozzle 7 to one another. The medium to be sprayed flows accordingly through the inner line coupling element flow channel 86, the double flange flow channel 87, the inner line flow channel 86 and the coupling head channel system 40 into the distribution chamber 66 and from there via the nozzle main body supply lines 64 to the nozzle 7. The aforementioned connection of all flow channels for the medium to be sprayed is also referred to as the inner flow channel. In the embodiment, the nozzle main body 8 is thus penetrated by three nozzle main body supply lines 63 and three nozzle main body supply lines 64.

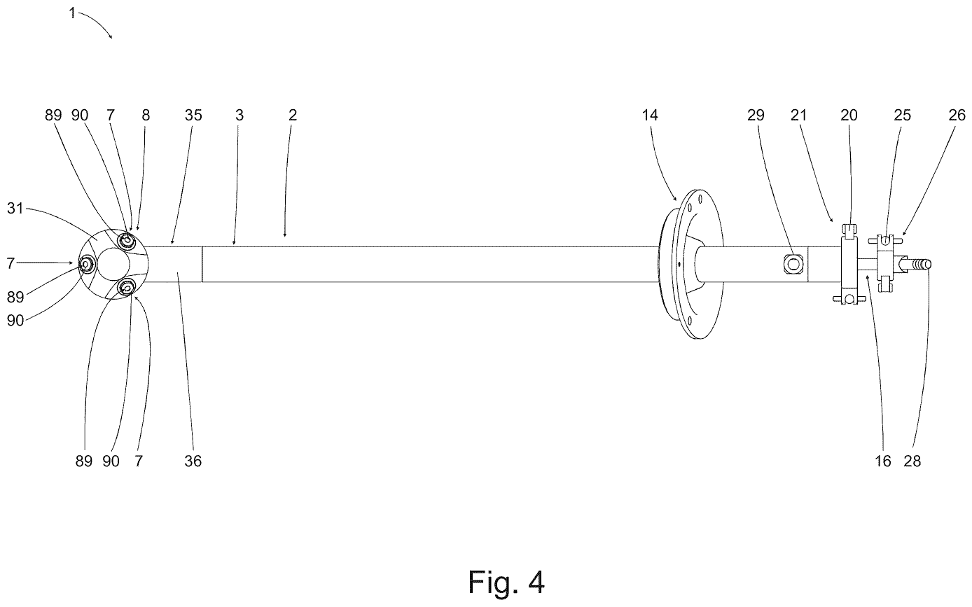

The nozzle main body 8, here the nozzle main body pot 31, comprises three nozzles 7, as shown in FIG. 4, a bottom view of the nozzle assembly 1. Another number of nozzles, e.g. four, five, six or more nozzles, is conceivable and feasible.

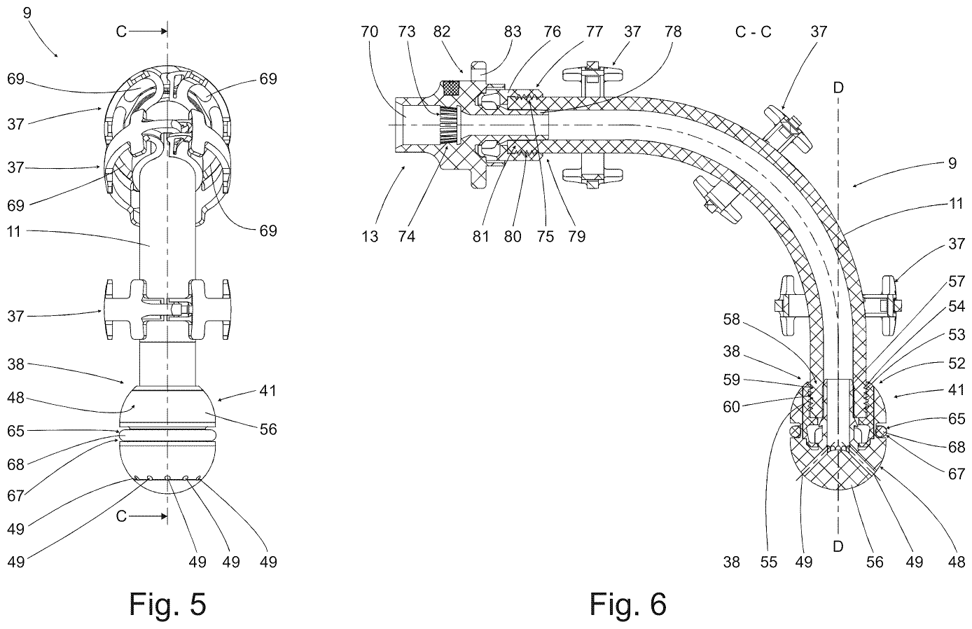

FIG. 5 shows a front view of the flexible inner line portion 11 comprising a coupling head 41.

The coupling head 41 is arranged on the inner line end portion 38 of the inner line 9. Coaxially around the flexible inner line portion 11 are arranged three spacers 37 comprising passage openings 69. The passage openings 69 allow the gaseous medium to flow almost undisturbed through the outer line flow channel 84 between the outer line 3 and the inner line 9 in the direction of the nozzles 7 arranged in the nozzle main body 8.

A sectional view of the flexible inner line portion 11 through a sectional plane C-C shown in FIG. 5 is shown in FIG. 6.

As already explained in FIG. 2, the connecting element 13 is arranged in the outer line 3 for connecting the rigid inner line portion 10 to the flexible inner line portion 11. The connecting element 13 comprises a connecting element channel 70 associated with the inner line flow channel 86, which channel passes through the connecting element 13 in the direction of flow of the medium to be sprayed.

For the connection of the rigid inner line portion 10 to the connecting element 13, the rigid inner line portion 10 comprises an external thread 72 at its outlet-side end section 71, which is screwed into a connecting element channel portion 74 comprising lamellae 73, so that a corresponding internal thread, which is not shown in relation to the external thread 72, cuts into the lamellae 73. Thus, the rigid inner line portion 10 is fixed in the connecting element 13.

Furthermore, the connecting element 13 comprises a connecting element fastening device 77 designed as a connecting element fastening sleeve 76 having an internal thread 75 for receiving the flexible inner line portion 11, with a connecting element connecting nozzle 78 of the connecting element 13 passing through said connecting element fastening device. At the same time, an external thread 80 is arranged on a supply-side end portion 79 of the flexible inner line portion 11.

A space 81 is formed between the connecting element connecting nozzle 78 and the connecting element fastening sleeve 76, into which space the flexible inner line portion 11, which comprises the external thread 80 at its end portion 79, can be introduced, so that the internal thread 75 of the connecting element fastening sleeve 76 and the external thread 80 of the flexible inner line portion 11 of the inner line 9 are operatively connected to one another and the flexible inner line portion 11 is fixed in the connecting element 13.

The connecting element 13 can also be connected to the rigid inner line portion 10 or the flexible inner line portion 11 by means of a different connection technique. For example, both the connection of the rigid inner line portion 10 to the connecting element 13 and the connection of the flexible inner line portion 11 to the connecting element 13 can be realized by means of a latching connection.

The connecting element 13 additionally comprises through-openings 83 in its outer area 82, whereby the gaseous medium can pass through the connecting element 13 positioned in the outer line 3 by flowing through the through-openings 83 in the direction of the nozzle 7.

FIG. 7 shows a side view of the coupling head 41 and FIG. 8 a sectional view of the coupling head 41 through a sectional plane D-D shown in FIG. 7, whereby a detailed description of FIGS. 7 and 8 is already anticipated by the previous description. However, FIGS. 7 and 8 are used in particular to provide a better overview.

1. A nozzle assembly having a line assembly which comprises:
an outer line conducting a gaseous medium and an inner line conducting a medium to be sprayed and arranged within the outer line,
a nozzle main body,
wherein a coupling element is arranged on an outlet-side inner line end portion of the inner line and on the nozzle main body respectively, wherein the coupling element is formed as a first coupling element and the coupling element is formed as a second coupling element with respect to this, the first and second coupling elements being adapted to be coupled to one another by means of a plug connection,
wherein the first coupling element is designed as a coupling head through which a coupling head channel system passes and the second coupling element is designed as a receiving bushing comprising a receiving space so that in the assembled state of the nozzle assembly the inner line is connected to the nozzle main body and the medium to be sprayed can flow from the inner line in the direction of the at least one nozzle.

2. The nozzle assembly according to claim 1, wherein the first coupling element is arranged on the inner line end portion of the inner line and the second coupling element is arranged on the nozzle main body.

3. The nozzle assembly according to claim 2, wherein the receiving space is defined by a receiving bushing wall and a receiving bushing floor.

4. The nozzle assembly according to claim 1, wherein the coupling head channel system comprises an inlet channel having a longitudinal axis and transitioning in a transition region into a plurality of outlet channels opening out on a surface area of the coupling head.

5. (canceled)

6. (canceled)

7. The nozzle assembly according to claim 4, wherein each outlet channel comprises an outlet channel cross-sectional area that is a multiple smaller than an inlet channel cross-sectional area.

8. The nozzle assembly according to claim 4, wherein each outlet channel comprises an outlet channel cross-sectional area that is smaller than a nozzle outlet cross-sectional area.

9. The nozzle assembly according to claim 1, wherein the coupling head comprises a coupling head fastening device for the inner line, the coupling head fastening device being a coupling head fastening sleeve having an internal thread or a first latching element.

10. The nozzle assembly according to claim 9, wherein the coupling head comprises a cap element positioned on the coupling head fastening sleeve.

11. The nozzle assembly according to claim 9, wherein the coupling head fastening device has the coupling head channel system passing through it.

12. The nozzle assembly according to claim 10, wherein the cap element passes through the coupling head fastening device on the rear side with a coupling head connection spout.

13. (canceled)

14. The nozzle assembly according to claim 12, wherein the inlet channel is coaxially enclosed by the coupling head connection spout.

15. The nozzle assembly according to claim 12, wherein a space is formed between the coupling head connection spout and the coupling head fastening sleeve, into which space the inner line, which comprises an external thread or a second latch element at its inner line end portion, can be introduced, so that the internal thread or the first latch element of the coupling head fastening sleeve and the external thread or the second latch element of the inner line are operatively connected to one another.

16. The nozzle assembly according to claim 12, wherein the first coupling element designed as a coupling head comprises a coupling head sealing element which provides a seal between the first and second coupling elements in the assembled state, so that the coupling head and the receiving bushing define a distribution space, the coupling head comprising a coupling head groove over its entire circumference for receiving the coupling head sealing element.

17. The nozzle assembly according to claim 1, wherein the nozzle main body has passing through it a first nozzle main body channel system for the gaseous medium and a second nozzle main body channel system for the medium to be sprayed, in order to conduct the corresponding media separately from one another from the line assembly to the nozzle.

18. The nozzle assembly according to claim 17, wherein the first nozzle main body channel system comprises at least a number of nozzle main body supply lines corresponding to a number of nozzles arranged in the nozzle main body, in order to conduct the gaseous medium to the respective nozzle.

19. The nozzle assembly according to claim 17, where the second nozzle main body channel system comprises a number of nozzle main body supply lines corresponding to a number of nozzles arranged in the nozzle main body, in order to conduct the medium to be sprayed to the respective nozzle.

20. The nozzle assembly according to claim 16, wherein the nozzle main body supply lines of the second nozzle main body channel system connect the distribution space and the respective nozzle to one another.

21. The nozzle assembly according to claim 16, wherein the nozzle main body is designed in two parts, a nozzle main body cover and a nozzle main body pot connected to one another by means of a bayonet coupling or a thread.

22. The nozzle assembly according to claim 16, where the inner line arranged within the outer line comprises a flexible inner line portion which is guided by at least one spacer within the outer line.

23. (canceled)

24. The nozzle assembly according to claim 22, wherein the flexible inner line portion is under pre-load, whereby the first coupling element is held in the second coupling element.

25. (canceled)

26. (canceled)
